(19) United States
(12) Patent Application Publication
(10) Pub. No.: US 2023/0020605 A1
(43) Pub. Date: Jan. 19, 2023

(54) METHOD AND SYSTEM FOR IN-STORE PURCHASE OF SECURITY-TAGGED ITEMS WHILE AVOIDING THE POINT OF SALE

(71) Applicant: MISHIPAY LTD., London (GB)

(72) Inventor: Mustafa Abedin KHANWALA, London (GB)

(73) Assignee: MISHIPAY LTD., London (GB)

(21) Appl. No.: 17/947,558

(22) Filed: Sep. 19, 2022

Related U.S. Application Data
(63) Continuation of application No. 16/099,703, filed on Nov. 8, 2018.

(30) Foreign Application Priority Data
May 11, 2016 (GB) 1608269.5

(51) Int. Cl. G06Q 20/32; G08B 13/24; G06Q 20/02; G07G 1/00; G07G 3/00; G06Q 20/20

(52) U.S. Cl. CPC G06Q 20/3223; G06Q 20/3276; G08B 13/246; G06Q 20/02; G07G 1/009; G06Q 20/325; G07G 3/00; G06Q 20/208; G07G 3/003

(57) ABSTRACT

A method and a system for enabling in-store purchasing of security-tagged merchandise, avoiding going through the point of sale of a retailer, are provided herein. The method may include the following steps: identifying, using a user-coupled device, a security tag attached to specific item to be purchased, wherein the security-tag is unique to the specific identified item; initiating a purchase request of said item via the user-coupled device, wherein the request includes a price of the item and identifiers of: the item, the security-tag identification, the retailer, and the user; attempting a transaction based on the purchase request, wherein the transaction is capable of being authorised by a third party; and indicating at a data repository associated with an in-store security gate sensitive to said security tag, that the security tag is no longer capable of initiating an alarm.

### CROSS-REFERENCE TO RELATED APPLICATIONS

This application is a Continuation of U.S. patent application Ser. No. 16/099,703 filed on Nov. 8, 2018, being a National Phase application of PCT International Application No. PCT/IB2017/052757, International Filing Date May 11, 2017, claiming priority of GB Patent Application No. 1608269.5, filed May 11, 2016, all of which are hereby incorporated by reference in their entireties.

### FIELD OF THE INVENTION

The present invention relates generally to the field of online transactions, and more particularly to an in-store purchase of security-tagged items.

### BACKGROUND OF THE INVENTION

Prior to setting forth the background of the invention, it may be helpful to set forth definitions of certain terms that will be used hereinafter.

The term ‘user-coupled device’ as used herein is defined as any portable electronic device that has data capturing capability (e.g. a camera) and means for communicating with a remote location. Specifically, user-coupled devices may include, but are not limited to: smartphones, tablet personal computers (PCs), wearable computers, near eye display, and the like.

The term ‘security tag’ as used herein is defined as any device attached to an item in a store that is configured to indicate to a security gate at the exit point of the store whether or not the item was paid for. In a case that the item was not paid for, an alarm or any other type of alert is invoked. Security tags may be implemented my various technologies while the popular one is radio frequency identification (RFID).

One of the ongoing challenges of retailers today is how to eliminate queues in their stores. Queues at the point of sale (POS) are known deterrents for buyers and thus affect the business on the retailer's side and the entire purchasing experience on the buyer's side.

Security tags such as RFID tags which are used as anti-theft measures pose a real challenge for any solution of in-store purchasing of items that wish to avoid the POS. Traditionally, a dedicated device at the POS disables the security tags and enable the buyer to take the purchased items through the security gate without sounding the alarm.

Any currently available in-store purchasing system that relies on RFID tags as anti-theft measures is required to have dedicated devices or capability of disabling the RFID tags by transmitting an RF signal that switches the RFID tag to an inactive state.

As currently available smartphones, most tablet PCs and any user-coupled devices do not have such RF signalling capability, it would be therefore advantageous to provide a solution for in-store purchasing of security-tagged merchandise that does not rely on disabling the RFID tags themselves.

### SUMMARY OF THE INVENTION

Some embodiments of the present invention provide a method of enabling in-store purchasing of security-tagged merchandise, avoiding going through the point of sale of a retailer, are provided herein. The method may include the following steps: identifying, using a user-coupled device, a security tag attached to a specific item to be purchased, wherein the security-tag is unique to the specific identified item; initiating a purchase request of said item via the user-coupled device, wherein the request includes a price of the item and identifiers of: the item, the security-tag identification, the retailer, and the user; attempting a transaction based on the purchase request, wherein the transaction is capable of being authorised by a third party; and indicating at a data repository associated with an in-store security gate sensitive to said security tag, that said security tag is no longer capable of initiating an alarm at said in-store security gate, only in a case that the transaction was authorized by the third party.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary architecture on which embodiments of the present invention may be implemented; and

FIG. 2 is a diagram illustrating an aspect in accordance with embodiments of the present invention; and

FIG. 3 is a flowchart diagram illustrating a method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing” “computing” “calculating” “determining” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

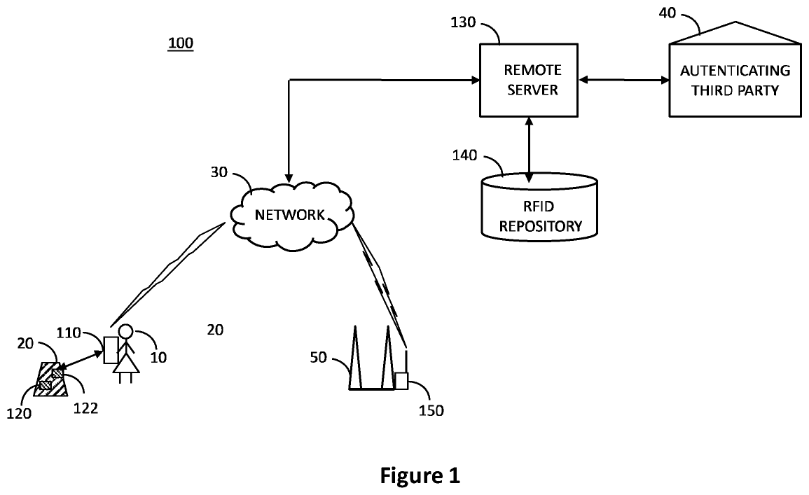

FIG. 1 is a block diagram illustrating an exemplary architecture on which embodiments of the present invention may be implemented. System 100 may include a user-coupled device 110 associated with a specific user 10. User-coupled device 110 may be a smartphone or a tablet PC or even a head worn device that has all the relevant details that identify user 10 with whom it is associated with. User-coupled device 110 may be configured to identify a unique identifier 122 of a security tag 120 attached to specific item 20 to be purchased. The unique identifier 122 may include a barcode or a quick response “QR” code or any identifier that identifies item 20 as belonging to a group of items having same details, price and the like and in addition, an identifier that relates specifically to security-tag 120 that is actually attached to item 20. Put differently, in accordance with embodiments of the present invention, the unique identifier 122 has a one to one relationship with the security tag 120 whereas security tag 120 has a one to one relationship with item 20 and so unique identifier 122 has a one to one relationship with item 20.

In accordance with some embodiments of the present invention, user-coupled device 110 is further configured to initiate a purchase request of item 20 wherein the request is conveyed via a network 30 (such as any wireless network e.g. cellular network). According to some embodiments, the request may include the minimal details required for authenticating a deal such as a price of item 20 and identifiers of: the item 20, the security-tag identification 122, the retailer, and the user 10.

In accordance with some embodiments of the present invention, system 100 may further include a remote server 130 connected to network 30. Remote server 130 may be configured to: attempt a transaction based on the purchase request, wherein the transaction is capable of being authorised by a third party 40. If, and only if, the transaction is authenticated, remote server 130 is configured to indicate at an RFID data repository 140 that security tag 120 associated with unique identifier 122 is no longer capable of initiating an alarm at the security gate 50. For example, a flag may be set to indicate whether or not a particular tag 120 should initiate or trigger an alarm.

In accordance with some embodiments of the present invention, a gate controller 150 can communicate possibly via network 30 with RFID data repository 140 and get updates in real-time on the status of each and every RFID used. Thus, when user 10 walks out of the store via security gate 50 with item 20 having security tag 120 attached to it, gate controller 150 can inform in-store security gate 50 whether or not to initiate the alarm based on the status of the RFID tag 120. For example, when a customer passes through the gate with an item from the retailer, the gate controller 150 may query the server 130 as to whether or not to initiate an alarm and the server will respond according to the status of the security tag 120.

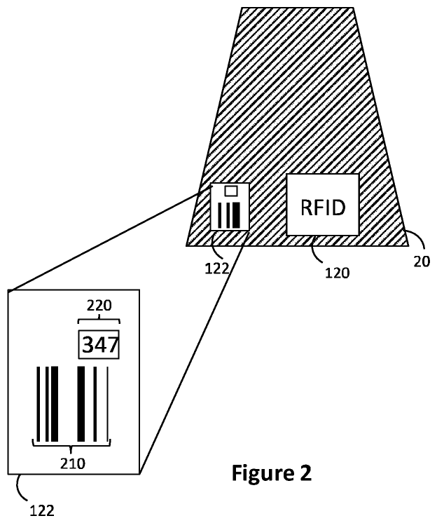

FIG. 2 is a diagram illustrating how items may be identified in accordance with some embodiments of the present invention. While RFID tags are used herein as an example, it is understood that any other type of security tags may be employed. Merchandise item 20 is shown with RFID tag 120 attached to it and unique identifier 122 also attached to item 20. A close look reveals that unique identifier 122 may, in some cases include two identifiers. One generic identifier 210 is the barcode or a QR code or something similar and is associated with the type or model of item 20. This can be the regular identifier or barcode provided by the retailer. An additional identifier 220 when included, may be unique and related to the RFID tag 120 rather than to item 20. The additional identifier may also be captured while capturing the barcode or the QR code by the user-coupled device as explained above. Thus, it is the tag that is being monitored rather than the item to be purchased. Thus the security status of the security tag can be changed remotely, e.g. “on the cloud” rather than locally on the tag itself.

For example, suppose that item 20 is a skirt. The generic identifier 210 may simply identify item 20 as a skirt and may also be used for other skirts of same model. The additional identifier 220 may identify the security tag. If there are ten skirts on sale ten security tags each with different IDs may be used to differentiate one skirt from another. The combination of the generic identifier and the additional tag identifier uniquely identifies the skirt that is being purchased. According to some embodiments of the invention, instead of monitoring individual items from their unique identity, only the tags need to be monitored. It will be appreciated that for such embodiments, ideally a retailer may have to use a different tag ID for each product, so that there is no overlap in tag IDs between different kinds of product and each product is uniquely identified. This will avoid e.g. a skirt and shirt having the same tag ID.

Advantageously, by physically separating the RFID and its unique identifier, it will be possible to have a small unnoticeable RFID tags embedded within item 20 so that RFID tag 120 will not need to be removed at all once it has been updated on the RFID data repository 140 that the RFID 120 is no longer capable of activating the security gate alarm.

According to some embodiments of the present invention, the identifying of the unique identifier may be carried out using image capturing and processing. It can be a number or an additional set of barcode lines or any other visual indicator.

According to some embodiments of the present invention, the processing comprises deriving unique identifier from a visual indicator attached to the item.

According to some embodiments of the present invention, the security tag comprises a radio frequency identification (RFID) tag and the security gate comprises an RFID reader.

According to some embodiments of the present invention, the hand held device is a smartphone, and wherein the capturing is carried out using a camera of the smartphone.

According to some embodiments of the present invention, the hand held device is devoid of RFID reading capabilities.

According to some embodiments of the present invention, the transaction is deemed successful only once funds from the purchaser are transferred to the retailer.

According to some embodiments of the present invention, the transaction is deemed successful only once funds from the purchaser are verified by the third party as authorised.

According to some embodiments of the present invention, the indicating at a data repository comprises updating a field associated with the respective security tag associated with the item for which the transaction has been approved, that the alarm at the security gate should not go off.

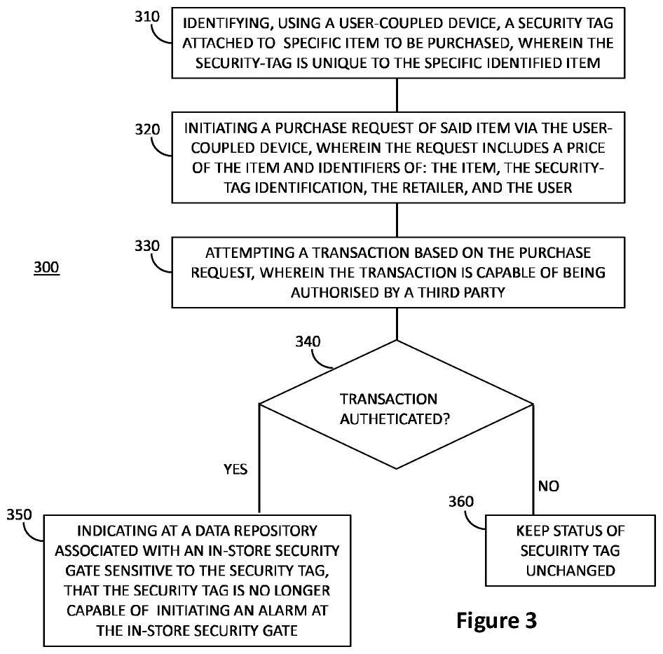

FIG. 3 is a flowchart diagram illustrating a method 30 of in-store purchasing of security-tagged merchandise, avoiding a point of sale of a retailer in accordance with embodiments of the present invention. Method 300 may include the following steps: identifying, using a user-coupled device, a security tag attached to specific item to be purchased, wherein the security-tag is unique to the specific identified item 310; initiating a purchase request of said item via the user-coupled device, wherein the request includes a price of the item and identifiers of: the item, the security-tag identification, the retailer, and the user attempting a transaction based on the purchase request, wherein the transaction is capable of being authorised by a third party 330. The transaction is the authenticated 340. In a case the authenticating is successful, indicating at a data repository associated with an in-store security gate sensitive to said security tag, that said security tag is no longer capable of initiating an alarm at said in-store security gate 350. In a case authenticating fails, no change is made (and the security tag remains active being the default) 360.

According to some embodiments, method 300 may be implemented as a transitory or non-transitory computer readable medium (CRM). The CRM may include a set of instructions that when executed cause at least one processor to: identify, using a user-coupled device, a security tag attached to specific item to be purchased, wherein the security-tag is unique to the specific identified item; initiate a purchase request of said item via the user-coupled device, wherein the request includes a price of the item and identifiers of: the item, the security-tag identification, the retailer, and the user; attempt a transaction based on the purchase request, wherein the transaction is capable of being authorised by a third party; and indicate at a data repository associated with an in-store security gate sensitive to said security tag, that said security tag is no longer capable of initiating an alarm at said in-store security gate, only in a case that the transaction was authorized by the third party.

In order to implement the method according to embodiments of the present invention, a computer processor may receive instructions and data from a read-only memory or a random access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon forming an embedded system.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fibre, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in base band or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fibre cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for enabling in-store purchase of security-tagged items, avoiding a point of sale of a retailer, the method comprising:
identifying, using a user-coupled device, a security tag attached to a specific item to be purchased, wherein the security-tag is unique to the specific identified item;
initiating a purchase request of said item via the user-coupled device, wherein the request includes a price of the item and identifiers of: the item, the security-tag identification, the retailer, and the user;
attempting a transaction based on the purchase request, wherein the transaction is capable of being authorised by a third party; and
indicating, at a data repository associated with an in-store security gate sensitive to said security tag, that said security tag is no longer capable of initiating an alarm at said in-store security gate, only in a case that the transaction was authorized by the third party, and otherwise not changing a status of the security tag,
wherein the user-coupled device is a smartphone, and
wherein the step of identifying is carried out using image capturing and processing using a camera of the smartphone.

2. The method according to claim 1, wherein the identifying is carried out using image capturing and processing.

3. The method according to claim 2, wherein the processing comprises item recognition.

4. The method according to claim 2, wherein the processing comprises deriving a unique identifier from a visual indicator attached to the item.

5. The method according to claim 1, wherein the security tag comprises a radio frequency identification (RFID) tag and wherein the security gate comprises an RFID reader.

6. The method according to claim 1, wherein the user-coupled device comprises RFID reading capabilities.

7. The method according to claim 1, wherein said indicating at a data repository comprises updating a field associated with the respective security tag associated with the item for which the transaction has been approved, that the alarm at the security gate should not go off.

8. A system for enabling in-store purchase of security-tagged items, avoiding a point of sale of a retailer, the system comprising:
a user-coupled device configured to:
identify a security tag attached to a specific item to be purchased, wherein the security-tag is unique to the specific identified item; and
initiate a purchase request of said item, wherein the request includes a price of the item and identifiers of: the item, the security-tag identification, the retailer, and the user; and
a remote server configured to:
attempt a transaction based on the purchase request, wherein the transaction is capable of being authorised by a third party; and
indicate at a data repository associated with an in-store security gate sensitive to said security tag, that said security tag is no longer capable of initiating an alarm at said in-store security gate, only in a case that the transaction was authorized by the third party, and otherwise not changing a status of the security tag,
wherein the user-coupled device is a smartphone, and
wherein the identifying is carried out using image capturing and processing using a camera of the smartphone.

9. The system according to claim 8, wherein the processing comprises item recognition.

10. The system according to claim 8, wherein the processing comprises deriving unique identifier from a visual indicator attached to the item.

11. The system according to claim 8, wherein the security tag comprises a radio frequency identification (RFID) tag and wherein the security gate comprises an RFID reader.

12. The system according to claim 8, wherein the user-coupled device is a smartphone, and wherein the capturing is carried out using a camera of the smartphone.

13. The system according to claim 8, wherein the handheld device is devoid of RFID reading capabilities.

14. The system according to claim 8, wherein the transaction is deemed successful only once funds from the purchaser are transferred to the retailer.

15. The system according to claim 8, wherein the transaction is deemed successful only once funds from the purchaser are verified by the third party as transferred.

16. The system according to claim 8, wherein said indicating at a data repository comprises updating a field associated with the respective security tag associated with the item for which the transaction has been approved, that the alarm at the security gate should not go off.

17. A non-transitory computer readable medium for enabling in-store purchase of security-tagged items, wherein the computer readable medium comprising:
a set of instructions that when executed cause at least one processor to:
identify, using a user-coupled device, a security tag attached to specific item to be purchased, wherein the security-tag is unique to the specific identified item;
initiate a purchase request of said item via the user-coupled device, wherein the request includes a price of the item and identifiers of: the item, the security-tag identification, the retailer, and the user;
attempt a transaction based on the purchase request, wherein the transaction is capable of being authorised by a third party; and
indicate at a data repository associated with an in-store security gate sensitive to said security tag, that said security tag is no longer capable of initiating an alarm at said in-store security gate, only in a case that the transaction was authorized by the third party, and otherwise not changing a status of the security tag,
wherein the user-coupled device is a smartphone, and
wherein the identifying is carried out using image capturing and processing using a camera of the smartphone.
